(19) United States
(12) Patent Application Publication
(10) Pub. No.: US 2014/0164129 A1
(43) Pub. Date: Jun. 12, 2014

(54) SYSTEM AND METHODS FOR PROVIDING TARGETED MESSAGES

(71) Applicant: Sanjaykumar Joshi, Fairfax, VA (US)

(72) Inventor: Sanjaykumar Joshi, Fairfax, VA (US)

(21) Appl. No.: 14/181,604

(22) Filed: Feb. 14, 2014

Related U.S. Application Data
(63) Continuation-in-part of application No. 13/561,147, filed on Jul. 30, 2012.

(51) Int. Cl. G06Q 30/02

(52) U.S. Cl. CPC G06Q 30/0261
USPC 705/14.58

(57) ABSTRACT

A system uses GPS or other location determining features and existing cellular services, along with a centrally available computer program. A vendor/advertiser can discover nearby consumers; the vendor/advertiser can publish a business communication such as promotion so that the consumer can discover the business announcements; the vendor/advertiser can send a one-on-one message to the consumer detailing the business announcement and call for action; and the consumer can obtain from the vendor/advertiser any clarifications, questions, feedback etc. regarding product/promotion. Individual users can use the system to identify and send messages to other individuals based on location.

### CROSS REFERENCE TO RELATED APPLICATIONS

This application claims priority under 35 U.S.C. §120 and is a continuation-in-part of U.S. application Ser. No. 13/561,147, filed Jul. 30, 2012, the disclosure of which is hereby incorporated by reference in its entirety.

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### INCORPORATION BY REFERENCE OF ELECTRONIC MEDIA

Not Applicable

### STATEMENT REGARDING PRIOR DISCLOSURES

Not Applicable

### BACKGROUND OF THE INVENTION

1. Field of the Invention

A system is described for providing targeted business messages (announcements, promotions, etc.) to potential customers near a business location. The system allows a location-based social messaging feature to provide a base of potential customers. The system of this invention leverages a social messaging customer base for targeted business messages. The invention employs multiple safeguards to protect privacy and promote safety from risks associated with location-based social technologies.

2. Related Art

### U.S. Patent Documents

20130226696
20090233629
U.S. Pat. No. 6,519,463
20020119788
20010018349
20100217661
U.S. Pat. No. 8,041,717
U.S. Pat. No. 6,813,501
U.S. Pat. No. 6,414,635
U.S. Pat. No. 8,108,254
U.S. Pat. No. 8,126,770
U.S. Pat. No. 8,136,044
U.S. Pat. No. 8,190,460
U.S. Pat. No. 8,195,133
U.S. Pat. No. 8,213,972.

There are several means by which a business advertiser can reach its target audience. The common examples of such media outlets are television, newspaper, mailers, magazines, computers, mobile devices, radio, point of sale printed material, etc. The advertiser selects the suitable media outlet based on their target audience and the cost to reach them. Most often, the advertisers will select more than one media outlet to have a broad reach for their message. There are many business needs where the target audience can be anyone who is nearby. To influence such an audience, many options exist, e.g. billboards, printed material, etc. This invention demonstrates another such avenue where an advertiser can target nearby potential customers who have shown willingness to receive such business announcements on a mobile device.

However, applications for mobile device-based targeted advertising have struggled due to low audience interest. Lack of interest is a multi-faceted problem. First, very few potential customers agree to grant access to applications that send unrequested advertisements. Second, even when customers do agree to this type of software, they frequently discontinue it due to annoyance or inconvenience resulting from advertisements. Some progress has been made by tying such location-based advertisements to games or videos that the consumer desires. This partial solution has its own limitations, foremost being limited to a particular game or video. Businesses desire a better way to have access to location-based electronic advertising to a willing customer base.

The present invention answers this problem by coupling targeted location-based business advertising with a location-based social messaging system. The location-based communication feature of the targeted advertising system may be used to support a social messaging system that allows users to contact each other based on the location of their mobile devices.

However, location-based social messaging presents even greater problems associated with compromised safety of individuals. Sexual predators have used location-based social messaging technology to track and victimize minors. See, e.g., People of the State of California ex rel. Dennis Herrera v. MeetMe, Inc. et al. (San Francisco Superior Court Case No. 537126, filed Feb. 3, 2014). The allegations in this litigation demonstrate that there is a heightened need to change some of the features of location-based social messaging to protect safety and privacy. This appears especially true concerning the need to protect minors from adults who may misuse this technology to commit crimes.

### BRIEF SUMMARY OF THE INVENTION

The present invention offers not only the synergy of advertising and location-based social messaging, but also novel protections that enable users to more safely use location-based technology to interact with both businesses and social contacts.

By using GPS or other location determining features and by using other existing technology of cellular services for business advertising, along with a centrally available computer program:
A. The vendor/advertiser can discover nearby consumers;
B. The vendor/advertiser can publish the Business communication (such as promotion) so that the consumer can discover the business announcements (promotion, etc.);
C. The vendor/advertiser can send one-on-one message to the consumer detailing the business announcement (e.g. promotion) and call for action to get the benefit announced; and
D. The consumer can reach back to the vendor/advertiser for any clarifications, questions, feedback etc. regarding product/promotion.

By using GPS or other location determining features in a social messaging system to be used in conjunction with targeted business advertising:
A. A private user can discover nearby individuals;
B. A nearby individual can elect to reveal personal information, such as location;
C. The private user can review personal information of a nearby individual;
D. The private user can send a text message to the nearby individual and propose further communication or social contact; and
E. The nearby individual can respond by text message.

### BRIEF SUMMARY OF THE DRAWINGS

FIG. 1 is a flowchart showing an overview of the business advertising system of the present invention.

FIGS. 2a and 2b are flowcharts showing the location-based social messaging feature of the present invention as used to find an activity partner.

FIGS. 3a and 3b are flowcharts showing the location-based social messaging feature of the present invention as used to organize a group trip.

FIGS. 4a and 4b are flowcharts showing the registration process for a new user who wants to use the location-based social messaging provided by the present invention.

### DETAILED DESCRIPTION OF THE INVENTION

The system and methods of the present invention combine I. Targeted Business Messaging; II. Personal Location-Based Social Messaging; and III. Security and Privacy Safeguards.

### I. Targeted Business Messaging

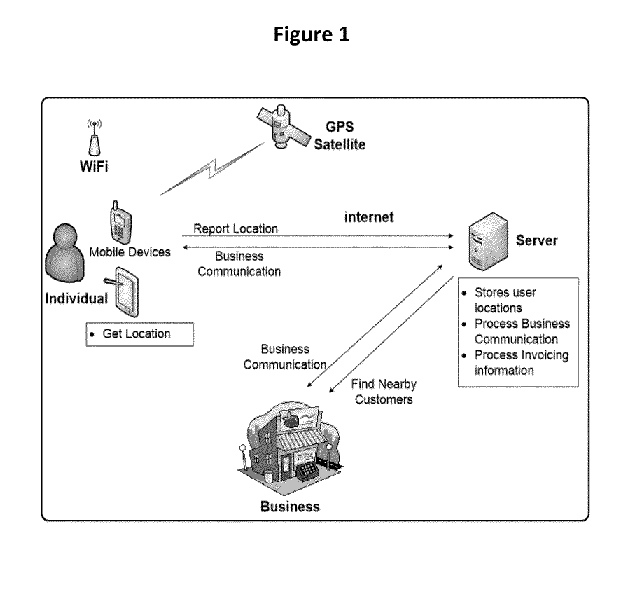

The main components are shown in FIG. 1:
Potential customers (Individuals) with a mobile device;
Business/advertiser with a desktop or mobile device; and
Central application (computer program) accessible by both the business/advertiser and the customers.
   A user can perform several functions on his or her mobile device, and also interact with the central application to achieve the benefits of the claimed invention. Stand-alone functions are shown in a rectangular box under the entity in the schematic.

Below are the stand-alone functions and their descriptions:

Get Location:

Many mobile devices such as cellular phones, tablet computers, etc. are capable of determining the device's geographical location at any time, based on Global Position Satellite (GPS), cellular tower or the Wi-Fi network. The claimed benefits are available when the set up as indicated by the enclosed schematic is established with individual actors performing their assigned functions. An individual using a mobile device can determine his/her location. The mobile device can determine its location using GPS satellites, the network address on the internet (using WiFi) or by using the known location of the cell tower being used.

Store User Location:

The central application can store the location of each active user when his/her mobile device reports a location for the user. When the same user's mobile device reports a different location, the central application updates his/her location in its database.

Process Business Communications:

The central application is responsible for storing and forwarding business communications to intended recipients. When a vendor/advertiser creates a business communication for nearby individuals, this function stores the message and forwards the message to an identified individual's mobile device. Similarly, if an individual has created a communication for a business user, this function within the central application will store and forward the message to the intended vendor/advertiser. The internet infrastructure acts as a communication link between the sending and receiving entities.

Process Invoicing Information:

This is an optional module at the central application. It can keep the account of the number of business messages sent on behalf of a business vendor/advertiser. The owner of the business application can charge the business vendor/advertisers based on number of messages sent successfully to the individual users.

The central application/computer program (also referred to as ‘application’) and the mobile device with location-determining function are the key enablers for this application. The following describes the key features needed from each of these components for the stated benefits to be available:

Application Features:

This part of the application has the following main components. The correct combination of all of them provides the stated benefits.

Server Component:

It can house all the account holders' information and has processing power to process any computing requirements. The key information for the account holder are: location, activity status (active, idle, logged off, etc.), name, contact information, business announcement detail, message details (time, sender, receiver, etc.), invoicing details etc. The major services that the server component can provide are:
Provide a list of account holders (both business and individual) near a location;
Show details such as account holder's status, location, preference, announcement (for business account holder), etc. of an account holder; and
Process and route the messages sent between two account holders
   All of above services results are displayed by the client component.

Client Component:

This can be enabled on the account holder's computer (desktop or mobile device). It provides usable functionality such as displaying the other account holders near a specific location, allowing the user interface to send and receive messages, providing user interface for creating a new account, signing in/out of the application etc. The location discovery can be displayed in either ‘map view’ (where other account holders are shown on a map of the location) or a ‘list view’ (where other account holders are shown in list sorted by the distance from the specified location).

Mobile Device Features:

The mobile device envisioned in this invention is the one with following key features available with it:

Computing processor: It should have reasonable computing processing capacity to process the workload placed by the account holder's interaction with the application in a timely manner.

Location determination: It should be able to determine the device's geographic location when requested by account holder/application.

User interface: It should provide a user interface, which allows the account holder to input alphanumeric input, select action out of options provided by the application, and be able to display the screen provided by the application.

Internet access: It should provide network access to the remote server through more common TCP/IP or any other means.

The drawing shows the basic configuration for such utility using a mobile device, GPS satellite, internet connection and the computer application.

Before the stated benefits for the consumer and the advertiser can be achieved, there are few preconditions that need to be met by both vendor/advertiser and consumers. Not all preconditions are needed for each benefit. The detailed procedure explaining the benefit below clarifies which precondition is needed for a particular benefit:

### Pre-Conditions

i. The consumer needs to accompany the mobile device that is used for discovering the location;
ii. The consumer needs to have an account with the application to communicate between the vendor and the consumer (such consumers are referred to as accountholder consumers);
iii. The consumer need to activate the application used to communicate between the vendor and the consumer;
iv. The consumer need to activate the location determining function on the mobile device;
v. The vendor/advertiser needs to claim the location of its establishment;
vi. The vendor/advertiser needs to have an account with the application to communicate between the vendor and the consumer;
vii. The vendor/advertiser need to activate the application used to communicate between the vendor and the consumer; and
viii. The vendor/advertiser need to activate the location-determining function on the mobile device.

The remaining examples explain stated benefits and procedures to achieve them.

A. The vendor/advertiser can discover nearby consumers. Precondition must be met: (i, ii, iii, iv, v, vi, vii).

When a vendor/advertiser wants to discover the potential consumers available through this media, he/she can log in to the application and send such request along with its own location to the server component, which in turn can reply with the account holder consumers who are near the location of the business. If the business user is at his/her business location and has location-determining function activated (precondition viii), the accountholder consumers can be discovered by implicitly providing the business location to the application behind the scene by the client component of the application.

B. The vendor/advertiser can publish the business announcement (such as promotion, etc.) so that the consumer can discover the promotion. Precondition must be met: (i, ii, iii, v, vi).

The application can allow the business user to announce their promotion or other business messages. This information can be stored along with other discoverable information regarding the vendor/advertiser such as name, type of business, location, etc. on the application server. The potential consumer can log in to the application and send the request querying the business along with its own location to the server component, which in turn can reply with the business details along with the business announcements or promotions.

C. The business user can send one-on-one business message to the consumer. Precondition must be met: (i, ii, iii, iv, v, vi).

The application server component along with client component on the mobile device can orchestrate sending and receiving instant message between the registered account holders. Using this functionality the business user can send the business message to an individual accountholder consumer. Such message is sent from the business user's computer device interface to the Application. The Application's server component processes these messages and forwards it to the intended user on the network. Such message can provide details of the message along with the means to claim the benefits in the announcement.

D. The consumer can reach back to the business user for any clarifications, questions, feedback etc. Precondition must be met: (i, ii, iii, iv, v, vi, vii, viii).

The application server component along with client component on the mobile device can orchestrate sending and receiving instant message between the registered account holders. Using this functionality the potential consumer user can send the message to the business user. Such message is sent from the consumer user's mobile device interface to the Application. The Application's server component processes these messages and forwards it to the intended business user on the network. Such message can include clarifications, questions, feedback on the product and/or services provided by the business user.

### II. Location-Based Social Messaging

As described above, a location-based social messaging system is designed to provide an active base of willing participants who have mobile devices and are likely to view the targeted business communications of the present invention.

This feature of the present invention allows an individual user to find other individual users for social messaging near his or her location.

While registering for the application, each individual user can provide some basic information that he or she wants others to see such as name, age, gender, interests, etc. Additionally, an application server may record a user-entered static location and a user mobile device reporting dynamic location. The application server can also record whether an individual user wants to be approached for certain networking opportunities. An individual user can discover other individual users willing to network near his or her location by obtaining a list of individual users that the system determines to be nearby.

A list of nearby application users can be displayed by requesting a list on the application user's mobile client component. The mobile client component sends a request to the server component along with requesting user's location. The application server component prepares the list of other application users near the requesting user's location who are willing to network. The application server component then passes on the list to the user's client component.

A user can select contacts to be invited. Once available on the mobile client component, an application user can select one or more contacts to invite on the system.

A user can send a message to invite contact or friends. After confirming the invitation, the mobile device component can pre-fill the text required for invitation. The application user can change the text and can opt to send an invitation request message. The client mobile component can then provide the details of the selected friend, the invitation text, and a required user credential to the application server component. The application server component can prepare the message in a format required by an external social media network and transmit it the message. A response received from the external social media network can be passed back to the application user's mobile component.

Contacts for messaging may be selected by search criteria including distance or location; a matching keyword; or a mutual friend by one or more users. In addition, a messaging contact may be selected based on a mutually desired activity, such as seeing a movie.

An individual user can create an avatar representing his or her personal information. This can enable faster visual review of potential and actual contacts based on graphic representation of personal information in the avatar.

In addition to providing the name and other information to the application server component as its profile element, an individual user can also provide an avatar, such as a profile picture he or she wants to be discovered by other users. When an individual user is searched for networking due to his or her proximity, name or other keywords, the application server component can process such requests and present a list of matching individual users. To find a particular networking member, the application user can review individual user profiles. A user profile can show public information such as name, interest, and a profile picture.

The application server component along with client component on the mobile device can orchestrate sending and receiving instant messages between the registered account holders.

In addition to providing a name and other public information to the application server component as its profile element, an individual user can also provide a profile picture he or she wants to be shown to other users. When an individual user is searches due to proximity, name, or keyword, the application server component processes such request and presents a list of matching individual users. To find the right networking member, the application user reviews the individual user profile. This profile shows public information such as name, interest and profile picture.

An individual user can initiate a request to connect with another individual user. This request is prepared at the client mobile device and is then transmitted to the application server component. The application server component processes such ‘connect’ request and sends it to the target user.

An individual user can accept a networking request from another individual user after receiving a networking invitation from another user. The application allows a user to decide whether he or she should “accept/reject” such request. If the application user decides to accept such request, he or she can indicate such choice in response to the invitation. Such a response is prepared at the client mobile device and then transmitted to the application server component. The application server component processes the acceptance and the person sending the original request sees the initial request has been accepted.

An individual user can reject a networking request from other individuals. After receiving a networking invitation from another user, an individual can decide whether he or she should “accept/reject” such request. If the application user decides to reject such request, he or she can send a response rejecting the invitation. Such a response is prepared at the client mobile device and is then transmitted to the application server component. The application server component processes the rejection and sends a message rejecting the invitation to the individual sending the original request.

An individual user can block certain other individual users to stop receiving messages from the blocked users. For example, upon receiving a networking invitation from another user, an application user can decide if he or she wants to not only reject the request, but also block that user from sending any further requests in future. If the application user decides to reject and block such request, he or she can indicate such choice in response to the invitation. Such a response is prepared at the client mobile device and transmitted to application server component. The application server component processes the rejection by sending a message letting the person sending the original request know about the response. In addition, the application server component will remove the target user's visibility from the blocked user in future. This is achieved by displaying only the users who have not blocked the specified application user. In this way, someone who is blocked will not see the users who blocked them on a populated contact or search list.

The application user can set various activities initiatives to invite other individual users to join. In addition to providing name and other information to the application server component as the profile element, the application user can also disclose an activity that the user wishes to engage in with others.

The application user's desired activities (initiatives) can be published for others to find. A user lists an activity which is then made public for other application users to see. The activity text can be made searchable so that other application users can discover others with common interests based on keywords within the activity text. When an application user is searched for networking by keyword, the application server component processes such requests and presents a list of matching individual users.

An application user can create group of like-minded application users. The application user may want to create a group of users to exchange messages with. The client component on the mobile device can provide a selection of users who are accepted into a network and let this group choose a name. Once such selection is made, the client component can provide such information to the server component which in turn notifies others that they have been added to a group. The group members can leave the group, invite others to the group, modify the group name, change the profile picture, delete a group conversation, etc., depending on which options the group creator has provided. The group creator can rename the group, add or remove a group member, delete a group and delete group messages.

Once a group is created successfully, a group member or group creator can send and receive messages with all the users within the group. To achieve this, the application server component along with client component on the mobile device can orchestrate sending and receiving instant messages between the registered account holders. When a member sends a message to a group, the application server component sends the message to all the client components of the mobile devices whose users are part of the group.

An application user can share his or her initiatives on other social media networks. To achieve this, the user can select the social media network he or she wants to use to share on his mobile client component. The mobile client component checks if it has user credentials necessary to post on the other social media network. If it does not have access, it requests the user to provide such credentials, such as a password, pass code, or answer to a security question. Once available, the mobile client component passes on the external social media credential as well as the selected activity description text to the application server component. The application server component posts the desired activity description (initiatives) on the other selected social media network and can provide status updates and return messages back to the user's client component.

An application user can invite friends or contacts from other social media networks to join this system. The application user can select his or her friends from the social media network that he or she wants to invite. The friend-list on such an external social media network can be shown by requesting it on the application user's mobile client component. The mobile client component checks if it has user credentials necessary to obtain the friend's list from the other social media network. If it does not, it requests the user to provide such credentials. Once available, the mobile client component passes on the external social media credential as well as a request to provide the friend's list to the application server component. The application server component prepares the request as required by the other the selected social media network and receives a response from the external social media network. The application server component then passes on the status back to the user's client component.

Once available on the mobile client component, the application user can select friends to invite on the networking system of the present invention.

After confirming the invitation, the mobile device component can pre-fill the text required for invitation. The application user can change such text and can send the invitation request. The client mobile component provides the details of the selected friend, invitation text and required user credential for the external social media network to the application server component. The application server component prepares the message in a format required by the external social media network and transmits it. A response can be received from the external social media network and passed back to the application user's mobile component.

An individual user can send a text message to invite his or her friends to join this social messaging system of the present invention. An application user can select his or her friends from a phonebook/contact list that they want to invite. The friend list on the application user's phone/mobile device can be shown inside the application. The user can approve or deny such access. The mobile client component checks if it has user approval necessary to obtain the friend's list from the phonebook/contact list. If it does not have permission, it requests the user to provide such approval. Once approved, the mobile client component prepares the request as required by the mobile device's program and receives a response from the device.

Once available on the mobile client component, the application user can select one or more friends to invite on this system. After selecting the friends from the phonebook/contact list, the mobile device can send the text message with pre-filled text that can be modified by the user. To send the text message, the mobile device component can use the device's mobile service provider to send a conventional text message using the target person's phone number.

An application user can also send an email message to invite his/her friends to join this system.

An application user can invite his or her friends who are listed in his or her phone book/contact list to use this system. The application user can select his/her friends from the phonebook/contact list that he/she wants to invite. The friend list on the application user's phone/mobile device can be shown inside the application. The user can approve or deny access. The mobile client component checks if it has user approval necessary to obtain the friend list from the phonebook/contact list. If it does not, it can request a user to provide such approval. Once approved, the mobile client component prepares the request as required by the mobile device's program and receives a response from the device.

Once made available on the mobile client component, an application user can select contacts or friends to invite on the system of the present invention. After selecting the friends from the phonebook/contact list, the mobile device can send an email message, optionally including pre-filled text, which can be modified by the user. To send the email message, the mobile device component can use the device's default email service provider program to send a conventional email message using the target person's email address.

An individual user can use the system of the present invention to see the location of his or her friends on a map. In addition to providing a name and public information to the application server component as its profile element, the individual user can also provide his or her location if he or she wants to be discovered by other users according to location. When an individual user searches for someone due to his or her proximity, name or other keywords, the application server component processes such requests and presents a list of matching individual users. To find a networking member, an application user reviews an individual user profile. This profile shows public information such as name, and interests, but also a user location.

The mobile client component may use various methods to obtain a user location.

A user may be asked to enter his or her address. This address may then be used to provide geolocation data, such as latitude and longitude of the user.

The Global Positioning System (GPS) capability of a mobile device may be used to find the latitude and longitude of the device and use that as user location.

Other means by which a mobile device can determine its location (for example, use of a particular cell phone towers, use of specific internet service provider, known Wi-Fi router access, etc.) can also be used to determine location. These and other geolocation methods for mobile systems are known in the art, and the present invention is not intended to be limited to any particular geolocation technology.

Another feature of the present invention allows an application user to rate individual users on their perceived social behaviors. An application user can rate any other application user to provide feedback on an individual user's social behavior. Social behavior in this context may be defined as the appropriateness of a user's social activity announcements, appropriateness of a user's public profile elements (e.g., name, interest, picture, etc.), and use of appropriate language during the message exchanges. Such rating feedback can be facilitated by offering a rating screen on the mobile client component which allows recording of ratings for users in a place where user's public profile elements are visible. Such a rating screen can also be provided in the conversation screen. On receipt of such rating from a user, the mobile client component can send the information of the rating and the target user information to the server component.

A rating system that may be employed by the present invention works as follows. A reviewer determines a value on a scale representing satisfaction obtained from a source provider. Collectively all such reviews allow a future potential consumer to determine if he or she wants to use a particular provider's service or not.

Preferably, a rating algorithm ties rating results with availability of enhanced system features. For example, the following features may be tied directly to the star-based rating received by an individual or a business advertiser:
Ability to display picture (needs 3 stars or higher)
Ability to write a custom status (needs 2 stars or higher)
Ability to initiate a conversation with another individual (needs 2 stars or higher)

The rating logic ensures that a user has more than one chance to qualify for enhanced features, and bad social behavior results in noticeable restriction for a reasonable time. Upon registering for the system of the present invention, everyone can receive a starter rating of 3 stars. A maximum of a 5 star rating is possible.

A unique rating is registered for each reviewer-reviewee combination to ensure that multiple reviews by a user do not get counted multiple times. An overall rating r is calculated by accounting for all the ratings rₙ by n users is calculated as: r=(3+Σrₙ)/n+1.

A user's rating may be increased by 0.25 stars every 4 days until it reaches a 4-star rating. Practically, this is a way to create a waiting period for certain features. The server component can record the information in the central repository where all the feedback for users are processed and stored.

A related feature of the present invention that crosses into the advertising system allows an application user to rate vendor or businesses on the products or services they offer. In a preferred embodiment, individual users rate businesses that are clients of the advertising portion of the system.

An application user that is a consumer of a business user's product or service can record his or her satisfaction. Such rating feedback can be facilitated by the application by offering a rating screen on mobile client component which allows recording of a rating for business users in a place where a business user's public profile elements are visible. Such a rating screen can also be provided in a conversation screen. On receipt of a rating from a user, the mobile client component can send the information of the rating and the target business user's information to the server component. The server component can record the information in a central location where all the feedback for all the users are processed and stored.

An individual user can rate anonymously other individual users or business users to flag inappropriate content.

An individual user can find other individual users based on their name, address, interest, etc. When registering for the application, an individual user can provide basic information that he or she wants others to see such as a name, age, address, gender, interests, etc. The application server can store this information if an individual user wants to be approached for networking opportunities. An individual user can discover other individual users willing to network based on the keywords in their name, address, interest and other fields.

An application user list matching a specified keyword can be shown by requesting a search on the application user's mobile client component. The mobile client component allows the requesting user to enter a keyword to be searched and sends such request to the server component. The application server component prepares the list of other application users who have a matching keyword in their name, email address, phone number, interest, address, etc. The application server component then passes on the list to the user's client component.

As described above, the present invention offers numerous ways to search for and interact with other users. A key part of the invention is the systems safeguards discussed in the following section.

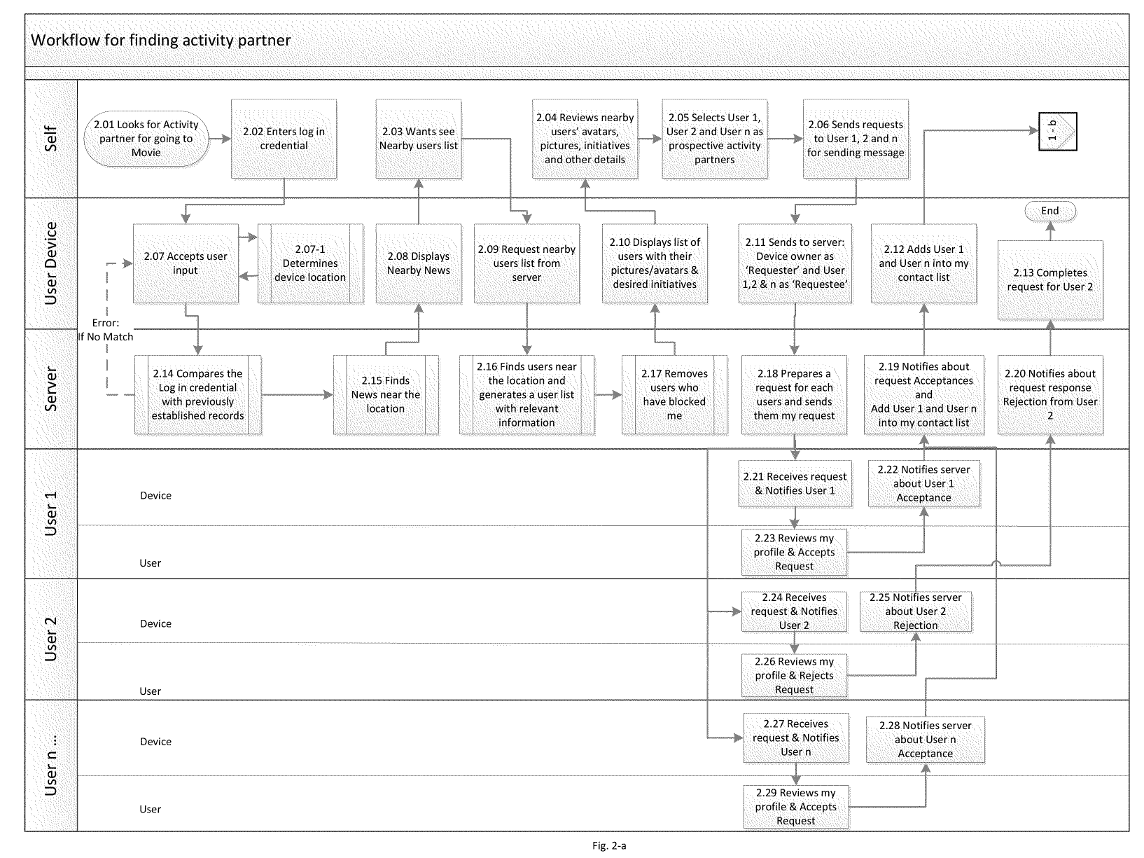

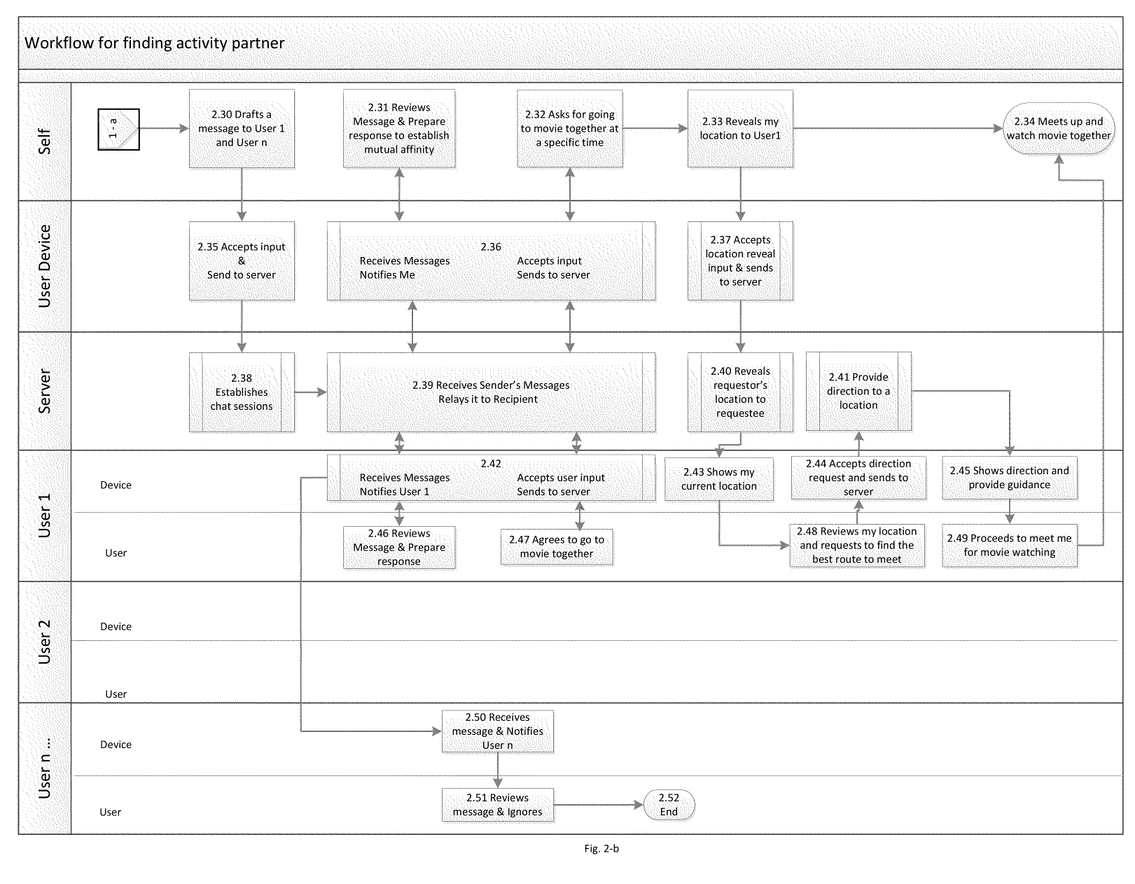

Features of the location-based social messaging system are further described in FIGS. 2a, 2b, 3a, 3b, 4a, and 4b.

FIGS. 2a and 2b show the system being used for social messaging based on users' locations. In this example, an individual user selects a social activity, specifically going to a movie 2.01. The first step of the method is to activate the system on the individual's user device, such as a smart phone, by logging in 2.02. Any of various log-in techniques may be employed for smart-phones or other mobile devices which are well known to those of skill in the art. Once the correct log-in information is provided, the system may accept the user input 2.07 and compares the log-in data with previously stored records for the user's profile 2.14, either on the server, on the user's mobile device, or both. This begins a series of steps.

The system can determine the location of the user's device 2.07, and find and display news for the location, 2.15 and 2.08. News may include updates to the user's profile, updates to contacts or friends, targeted business communications or advertisements, or requests from other users based on location or existing contact information. The user may proceed to check whether there are nearby users who are part of the system by initiating a search of nearby users 2.03. The search request is communicated to and processed by a server 2.09 that can find other users nearby and generate a user list with relevant information 2.16. This information may or may not include a specific location depending on individual settings. It is possible that no specific location data is shared at this point, except for the server to anonymously determine nearby users. If any users have previously been blocked, the server will remove that user from visibility 2.17. The server can then populate a list appearing on the requesting user's device screen 2.10. The list can include nearby contacts with accompanying information such as name, nickname, distance, location, gender, age, desired activities, or other information. The user can review the list and select one or more users from the list to contact 2.04. In this example, the user selects a User 1 and a User 2 as prospective activity partners 2.05 and enters data on the user's mobile device 2.06. The system sends a request from the user's device to the server to send messages to User 1, User 2, and User n 2.11. The server receives and processes the request for each targeted user, in this example, User 1, User 2 and User n, and sends a request in the form of a text message, email, or other electronic message to the mobile device of each 2.18. User 1, User 2, and User n receive the request on their mobile devices 2.21, 2.24, and 2.27. Each of the users can receive and review the message on their mobile device and then elect to accept or reject the request, 2.23, 2.26, and 2.29. In this example, User 1's mobile device notifies the server of the acceptance 2.22, as does User n's device 2.28. User 2's device sends notification of rejection to the server 2.25 which results in a record made on the server 2.20 that ends in a message sent to the requesting user's mobile devise advising of the rejection 2.13.

In response to the positive notifications from User 1 2.22 and User n 2.28, the requesting user can prepare a message for the accepting users 2.30. This is forwarded to the server 2.35, which in this example initiates one or more chat sessions 2.38, which in turn are relayed by the server back to User 1 and User n 2.39. User 1 and the requesting user then can exchange a series of instant messages via their mobile devices 2.42. Messages may be exchanged that establish a mutual interest or affinity. 2.31. If the original user proposes going to a movie at a specific time 2.32, User 1 can send a return message accepting 2.47. User n might receive a similar invitation to go to a movie 2.50 but might ignore the invitation 2.51, which will end the messaging session after a predetermined amount of time 2.52.

At some point after making successful contact, the original user may wish to reveal their specific location to User 1 2.33 by selecting a setting or option available on the mobile device to share location. The user's mobile device then communicates with the server, sending a message that may reveal the users location 2.40. User 1's mobile device can receive this message and display a map with the specific location of the original user 2.43. User 1 can review the location and activate a navigation feature on their mobile device to propose a route to meet 2.48. If User 1 accepts the proposed route 2.44, the server can process the proposed route and either share with the original user or provide specific directions to a location 2.41 and provide real-time guidance while User 1 goes to meet the original user 2.45, ultimately meeting each other 2.49 and proceeding to the movie 2.34.

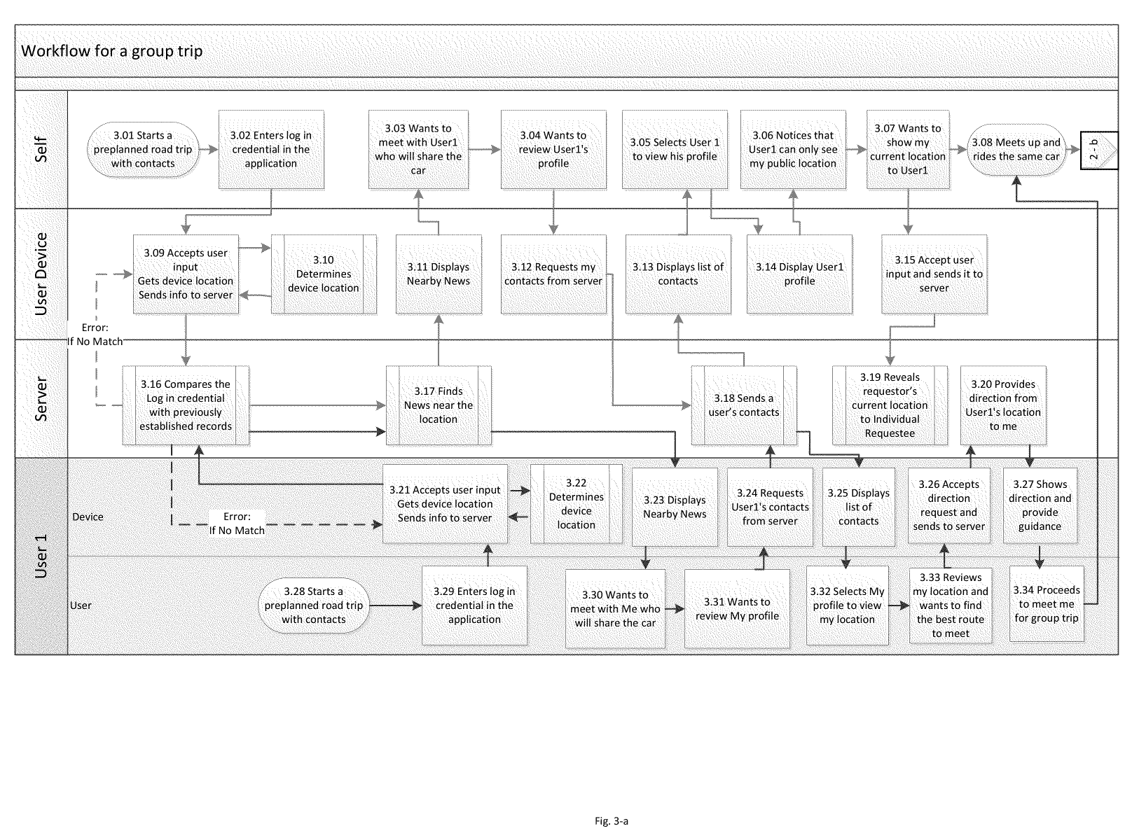

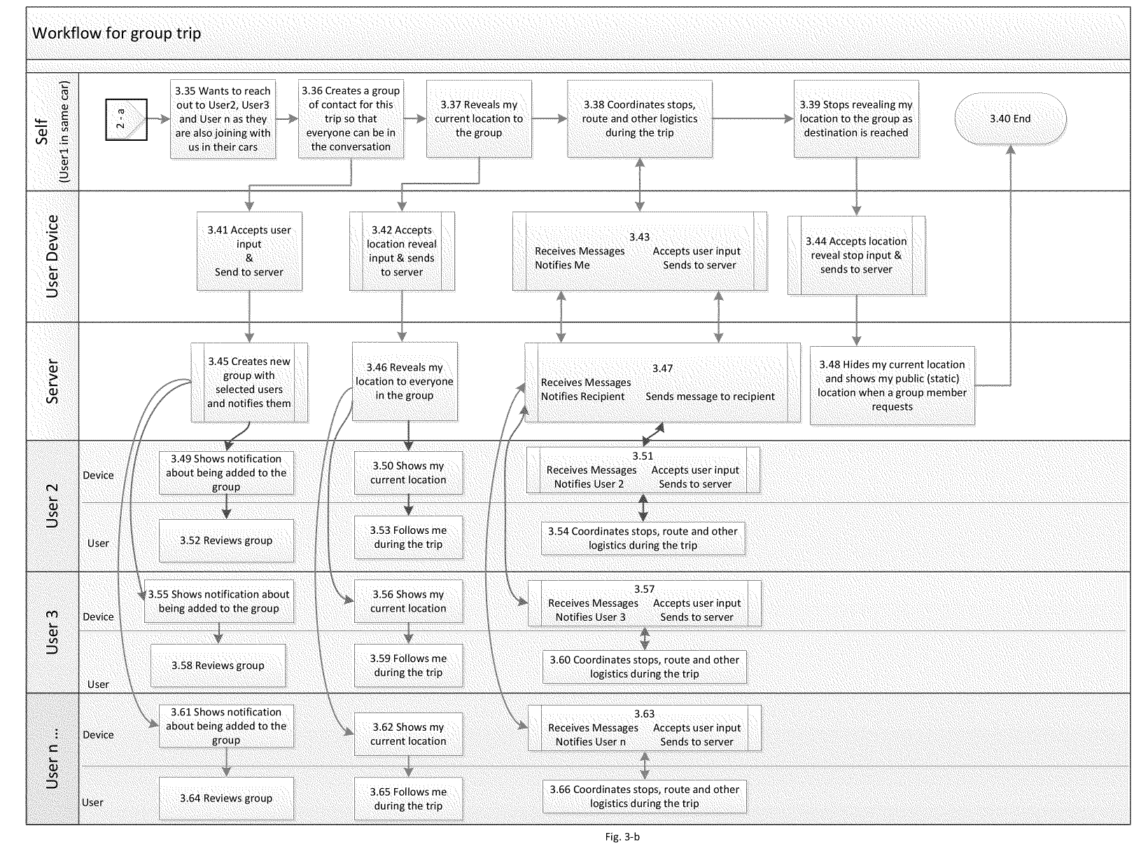

FIGS. 3a and 3b are flowcharts showing the location-based social messaging feature of the present invention as used to organize a group trip. In this example, starting on FIG. 3a, an initial user employs the system of the present invention to send messages to organize contacts to participate in a trip 3.01. After entering log in information 3.02, which is accepted by an application on a mobile device such as a smart phone 3.09, a server of the claimed system validates the log-in information comparing it with prior information 3.16. The mobile device determines its location 3.10 and looks for news near the location 3.17.

User 1 also starts a trip 3.28 desiring to travel all or in part with someone else. After entering User 1's log in information 3.29 which is validated 3.16 and accepted by an application on a mobile device such as a smart phone 3.21, User 1's mobile device determines its location 3.22, forwarding the location to the server 3.21 and looks for news near the location 3.17.

User 1 receives nearby news displayed on his or her mobile device 3.23. The news may identify the nearby user who is planning a trip by car. User 1 elects to meet with the user hoping to share his or her car 3.30. User 1 proceeds by reviewing the user's profile 3.31 accessible from the news display. User 1 may then request a list of the initial user's contacts from the server 3.24, which can return a contact list 3.18 to be displayed on User 1's mobile device 3.25. User 1 can elect to view the initial user's location 3.32, and then select an option to review a proposed route using navigational software on his or her mobile device. User 1's mobile device can communicate with the server and accept a route direction proposal 3.26 and 3.20. Proposed directions and mapping can be displayed on User 1's mobile device. Following these directions, User 1 proceeds to meet the initial user 3.08.

FIG. 3b continues the process of organizing a group trip. The initial user decides to contact User 2 and User 3 3.35. The initial user creates a group of contacts for everyone going on the trip so that messages can be distributed to everyone going on the trip 3.36. This is forwarded from the mobile device to the server 3.41 which groups the selected contacts under a common distribution key 3.45. The server can then create individual messages to be sent to User 2, User 3, and User n 3.45 which are forwarded to the users' mobile devices, providing a notification to each about being added to a group 3.49, 3.55, and 3.61.

User 1, User 2 and User n can review the group 3.52, 3.58, and 3.64. The initial user can elect to reveal his or her location to the others 3.37, 3.42, and 3.46. The server forwards the initial user's location to User 1, User 2 and User n, 3.50, 3.56, and 3.62; allowing User 1, User 2 and User n to see and follow the initial user during the trip 3.53, 3.59, and 3.65.

The initial user can use the social messaging distribution system of the present invention to coordinate stops, route changes, and other logistics during the trip 3.38. The initial user can enter a message into his or her mobile device 3.43 which is sent to the server 3.47 and then distributed to each of User 1, User 2, and User n 3.51, 3.57, and 3.63. This provides an opportunity for User 1, User 2, and User n to review the instruction and provide feedback, such as an alternate proposal. 3.54, 3.60, and 3.66.

When the destination is reached, the initial user elects to stop revealing his or her location 3.39. This setting is changes on the mobile device 3.44 and then conveyed to the server 3.48 which stops showing a real-time specific location and instead shows a public location from the user's profile, for example his or her home town, a shopping mall, school, or other place. This change is reflected by the server when other users review the profile 3.40.

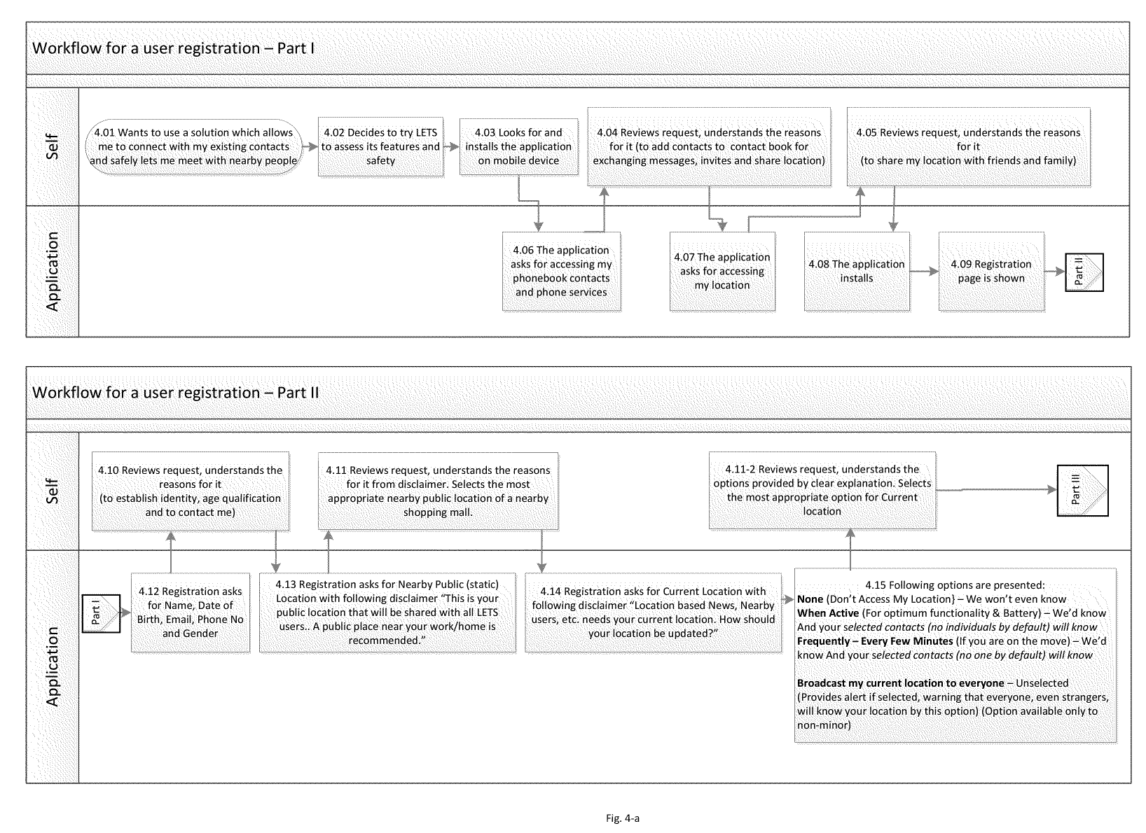

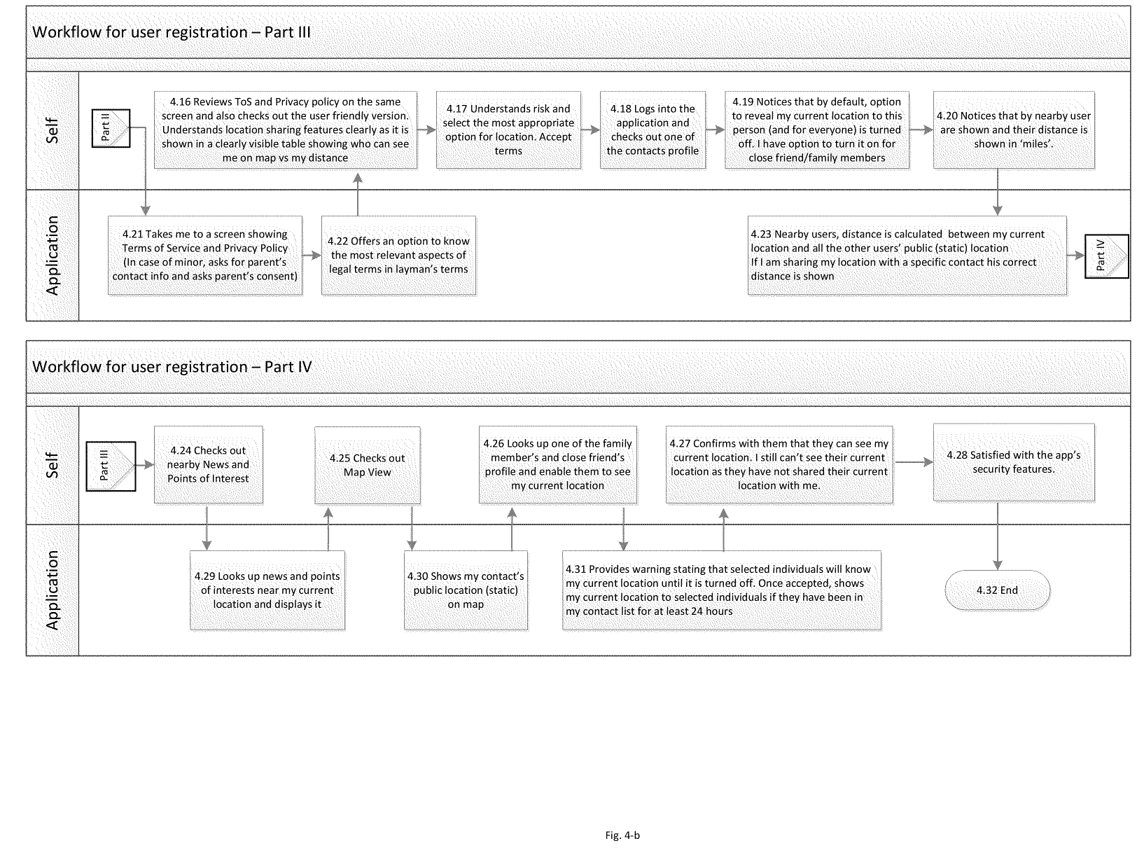

FIGS. 4a and 4b are flowcharts showing the registration process for a new user who wants to use the location-based social messaging provided by the present invention. In the example shown in FIG. 4a, a user wishes to use the system of the present invention to allow him or her to connect with existing contacts and safely meet nearby people 4.01. After deciding to try the present invention 4.02, the user locates and selects installation of an application for the present invention on a mobile device such as a smart phone or tablet 4.03. The application requests access to the user's mobile device phone contacts 4.06. The user can review the request and any additional warnings or preliminary user agreement 4.04. The application can ask to access the user's location 4.07. The user can review the request and any further warnings or user agreement 4.05. The user can agree and commence downloading the application 4.08.

Upon successful installation of the application for the present invention, a registration page is displayed on the user's mobile device 4.09. The user reviews the registration page 4.10, which asks for contact and personal information such as name, gender, age, email and telephone number 4.12. Registration asks for a Nearby Public Location with following disclaimer “This is your public location that will be shared with all users . . . . A public place near your work/home is recommended.” 4.13. The user reviews the request, understands the options provided by a clear explanation, and inputs an appropriate option for public location, such as a nearby city or shopping mall 4.11. Registration then asks for Current Location with following disclaimer “Location based news, nearby users, etc. needs your current location. How should your location be updated?” 4.14.

The application then displays a screen presenting the following options: “None (Don't Access My Location)—We won't even know; When Active (For optimum functionality & Battery)—We'd know And your selected contacts (no individuals by default) will know; Frequently—Every Few Minutes (If you are on the move)—We'd know And your selected contacts (no one by default) will know; Broadcast my current location to everyone—(Provides alert if selected, warning that everyone, even strangers, will know your location by this option)” 4.15. The user reviews the request, understands the options provided by a clear explanation, and inputs an appropriate option for current location 4.11.

FIG. 4b shows the continuation of the registration process. The mobile device displays a screen displaying terms of service, privacy policy and possible warnings 4.21. A feature of the registration steps for the present invention is an option offering to explain relevant aspects of terms of service or the privacy policy in layman's terms 4.22. The user then reviews the terms of service and privacy policy with the assistance of the application 4.16 and can accept the terms 4.17.

The user can then log in and review a contacts profile 4.18. By default, the option to reveal “Current Location” is turned off for everyone 4.19. The new user has the option to turn it on for various classes of users, such as VIP's, contacts, a particular group, or all users. A user can also elect to show distance only, and never current location 4.23, 4.20.

Upon registration, a new user can be prompted to view “Nearby News and Points of Interest” 4.24. By making a corresponding selection on the display of the mobile device, a server can forward news and points of interest based on the new users location 4.29. An option is provided to use a map view 4.25 which can display nearby points of interest shown on a map 4.30.

The new user can look up a family member's profile and select a setting that allows that family member to see the user's current location 4.26. A warning can be provided about the risks of sharing current location 4.31. The new user cannot view another user's current location until the other user specifically selects a setting to allow the new user to have access to their current location 4.27. If the user is satisfied with the initial security features 4.28, the registration process concludes 4.32.

### III. Privacy and Security Safeguards

As described above, the present invention combines targeted advertising with location-based social messaging, thereby providing an unexpected synergy. However, prior versions of location/based social messaging have been accused of serious problems associated with privacy breaches and security faults compromising the security of users, especially minors. Therefore, the present invention offers a carefully developed multi-layered system of security and privacy features. The particular balance and type of security features of the present invention serves to protect individual users without resulting in too much loss of interest, thereby preserving a critical amount of potential customers for targeted business advertisement messaging.

The system of the present invention contains a special screen that appears when an individual registers. This screen requests the individual's age to determine whether the individual is a minor. A second screen may be employed to explain why it is important for a minor to enter the correct age if he or she wants to be able to use the system. If the individual responds that they are below the age of 18, the system automatically displays a screen that directs the individual to have a parent or legal guardian accept a terms of services agreement. As part of this consent process for a minor, the system may require an email or mobile phone address for the parent. This serves both to validate consent by the minor's parent, and to provide a communication channel employed for further safeguards. As part of the registration process for the minor, an email or text message may be sent to the parent or guardian who approves the terms of the agreement stating that the minor has registered for a location-based social messaging system and explaining risks associated with the system.

The present invention may automatically provide minors with a more detailed initial warning and privacy notice. Additionally, the present invention may have a feature that offers layman's definitions for portions of the user agreement and privacy notice. For example, when a user hovers over a clause of a user agreement, a small window may appear with the meaning described in plain English. This is intended to benefit all users, but especially minors who may not understand the entire user agreement.

Additional warnings are provided for users as they progress through registration to select settings to be used for the location-based messaging system, both for options for advertisers and social messaging. A screen may require the user to check a box or otherwise confirm that they have read and understand a warning. Additional warnings may appear on screens each time a user changes a setting to allow increased visibility to other users, or increased information. A special warning may be displayed when a user proceeds to use the location-based mapping feature that may reveal his or her location to others. More specifically, a minor can be prompted with a screen that informs them of the increased risks of revealing their location to others. The system can also prompt a user to select alternatives to revealing specific location, such as distance only, or a less specific location such as a city, or telephone area code. In this way, the present invention strives to ensure that the user understands the privacy and security risks in using the messaging systems of the present invention.

Ongoing warnings may be provided to users, especially minors, each time the user's location information is accessed by another user more than a certain number of times.

The system of the present invention provides structural steps to limit the ease in which a minor may reveal their specific location to others. These additional steps may be required each time an individual adds someone to their contact list and elects to reveal their location to that user. Additional steps may include warnings and automatic messages to a parent or guardian. The parent or guardian may remotely monitor a minor's activity, and have the option to remotely approve these changes.

The system can require that an individual add someone to a group of contacts stored on the mobile device before allowing them to be included on a list of users who may access the location of the individual. Only after someone is successfully added to the contact list can the individual then proceed to elect to share his or her current location or other information with that person.

Another safety feature of the present invention is the limitation of certain features according to a user's age. A minor for example, can be provided with additional warnings and consent notices as compared with an adult. The system of the present invention can be made unavailable for users below a certain age. A parent or guardian may select settings to limit the information provided to others when a minor is using the system. Rather than showing actual age, the system can display age ranges of users. Age ranges might include under 20; 20-29; 30-39; 40-47; and 48+. While other age ranges may be employed, this group of ranges is especially preferred.

As set forth above, the system can require an email or text address for a parent of a minor. This address can be used to send notices to a parent or guardian of a minor. Events that can trigger a safety notice to a parent or guardian include: registering as a new user; creating a user profile with an age below a certain age, especially 18; selecting a setting that enables revealing location; adding a person to a contact or friend list; selecting a setting that reveals location to that individual; revealing a specific user location to another user; and repeated tracking of one's location by another user. The system of the present invention seeks to employ a careful balance of safety warnings that informs the user without causing excessive annoyance or loss of interest in using the system.

When a user elects to reveal their location, a default setting can initially show location only to individuals already on that user's contact list or to the parents of a minor. Careful use of default settings is a key safety feature, especially combined with warnings and notices sent to parents. In the case of a minor, the system makes it progressively more difficult to a minor to reveal their exact location or other specific personal information.

A further safety feature is providing different user information in response to business advertising queries as compared to social messaging networking requests. For example, while a user will have an option to reveal specific location to a social messaging user; the system can limit information responses to business advertiser inquiries to distance only rather than location.

Additional safeguards include preventing unwanted dissemination of personal or location information to third party vendors or others who are not registered with the system of the present invention.

With respect to business advertising users, privacy may be enhanced by requiring new user applications to undergo a personal review to confirm that a new business user is a legitimate business. The present invention can channel new business user applications to a server that in turn processes the information to allow a streamlined review process to minimize time required to review business applicants.

A further security measure is a waiting period that can be imposed for individuals, for example minors, between the time they select an option to reveal their location to a specific individual and the time that the system will allow someone else to see that person's specific location.

The system also employs the rating system described above to filter certain individuals. If an individual receives unfavorable ratings, the system may interrupt or stop that individual from having specific location information. An intermediate response to an unfavorable rating is to remove the specificity of location that is reported, for example a city or distance rather than the exact location of a user.

Throughout the description of the claimed invention, reference is made to the location of a user or the distance of a user. The present invention recognizes a strong correlation between the location of a user and the location of their mobile device. While a user may not always have their mobile device with them, for the purpose of describing the claimed invention, it is assumed that most of the time, the location of a user will be the location of his or her mobile device. Therefore, the location of a user is meant to be interchangeable with the location of a user's mobile device for the purpose of this patent application, including the claims.

The above detailed description explains the various examples of the present invention. Certain modifications are within the knowledge of those who design and implement mobile phone applications, including some modifications that would be within the scope of the claimed invention. The examples described are intended only to illustrate embodiments of the invention and not to limit the other various embodiments of the claimed invention.

I claim:

1. An integrated system using mobile devices and a centrally available computer program for sending targeted messages, the integrated system comprising:
a first system for using a centrally available computer program for communicating with potential customers near a place of business, the system comprising: a plurality of potential customers, each with a mobile device comprising a computer processor, a location determining function, a user interface for alphanumeric input, a display screen, and internet access;
a business with a computer; and
an application accessible by the mobile devices of the potential customers, the application comprising a server component and a client component,
the server component having account information for potential customers and a business, and processing capabilities for providing a list of account holders with a mobile device near a location, for storing the potential customers' locations, for updating potential customers' locations, for forwarding the distance from a potential customer's mobile device to the business, and for forwarding a business communication to potential customers near a location as determined by distance from the business, and
the client component having a display and an interface to send and receive messages, to display certain information about a potential customer including distance from the business, and the ability to automatically respond to the business communication;
a second system for sending location-based social messages, comprising: a first user with a mobile device and a second user with a mobile device; an application accessible by both mobile devices, the application comprising a server component and a client component,
the server component having account information for users who have installed the application on their mobile device, and processing capabilities for: providing a list of users with a mobile device near a location, for storing users' locations, for updating users' locations, for forwarding the distance from a first user's mobile device to the second user's mobile device, and for forwarding a message from the first user's mobile device to the second user's mobile device, and
the client component having a display and an interface, to send and receive messages, to display certain information about other users including distance, current location on a map, and specified user interest; and
safety measures to protect a user from risks associated with the location-based social messaging features, comprising: a setting on a user's client component that shows a location other than the user's specific current location; a rating system that restricts the ability of a user below a certain rating to determine the current location of another user; and automatic reporting for a user below the age of 18 to the user's parent each time the user elects to reveal their current location to another user.

2. The system of claim 1 further comprising: a waiting period for a new user between the time of registration and being able to view the current location of another user.

3. The system of claim 1 further comprising: a user profile and avatar for a user where the avatar represents personal information about the user including gender, and can be displayed on the mobile device of another user.

4. The system of claim 1 further comprising: a feature on the server component that allows a user to form a group of contacts, assign a name to the group of contacts, distribute messages to the group of contacts, and see the locations of users in the group of contacts.

5. A method for using cellular services and a centrally available computer program for communicating with potential customers near a place of business and for location-based social messaging, the method comprising:
(a) location-based business advertising messaging, comprising:
establishing a server component for storing account information of a business and account information of potential customers;
storing information describing the business;
storing a business communication to be communicated to nearby potential customers;
providing an application for mobile devices used by potential customers;
activating the application on a potential customer's mobile device to allow communication between the potential customer and a business;
determining the location of a potential customer by obtaining the location of the potential customer's mobile device;
communicating the location of the potential customer to a central application;
creating a list of potential customers having a location near the business;
forwarding the business communication to nearby potential customers' mobile devices;
(b) location-based social messaging, comprising:
determining the location of a user;
matching the location with a user profile stored on a server component;
comparing the location of the user to the location of other users;
distributing a list of nearby users;
allowing a user to select a nearby user appearing on the list of nearby users;
providing messaging between the user and nearby user;
allowing the user to see the location of the nearby user on a map; and
forwarding a message to the nearby user; and
(c) safety procedures, comprising
requiring a user to report their age;
requiring a user below the age of 18 to have their parent agree to a user agreement;
recording contact information for the parent; and
sending a message to the parent when the user below the age of 18 changes a setting to allow his or her current location to be seen by other users.

6. The method of claim 5 further comprising: requiring a new user to wait a specified time between when the new user registers and when the new user is able to see the current location of another user.

7. The method of claim 5 further comprising: providing an option to a user that shows other users a location other than the user's current location.

8. The method of claim 5 further comprising: providing an option to a user to display the user's current location to a selected group of users at a given time.

9. The method of claim 5 further comprising: allowing a user to search for other users based on a specific interest.

10. The method of claim 5 further comprising: creating an avatar that graphically represents information and is displayed to other users.

11. The method of claim 5 further comprising: restricting a user's access to one or more application features based on a rating that aggregates ratings provided by other users.
